(19) United States
(12) Patent Application Publication
(10) Pub. No.: US 2021/0302952 A1
(43) Pub. Date: Sep. 30, 2021

(54) INFORMATION DISPLAY DEVICE, INFORMATION DISPLAY METHOD, AND INSTRUCTIONS

(71) Applicant: YOKOGAWA ELECTRIC CORPORATION, Tokyo (JP)

(72) Inventor: Takamasa Kumaki, Tokyo (JP)

(73) Assignee: YOKOGAWA ELECTRIC CORPORATION, Tokyo (JP)

(21) Appl. No.: 17/186,380

(22) Filed: Feb. 26, 2021

(30) Foreign Application Priority Data
Mar. 27, 2020 (JP) 2020-059139

(51) Int. Cl. G05B 23/02

(52) U.S. Cl. CPC G05B 23/0272; G05B 23/0297; G05B 23/027

(57) ABSTRACT

An information display device, includes: a display that displays a display screen including information on measurement values respectively corresponding to measurement tags; and a controller. When one or more of the measurement values are greater than a first threshold, the controller causes the display to display a first pop-up screen, including information on the one or more measurement values, superimposed on the display screen.

### BACKGROUND

### Technical Field

The present disclosure relates to an information display device, an information display method, and instructions.

### Related Art

When monitoring data of a plurality of recorders or measuring instruments, the recorders or measuring instruments are connected to a PC (personal computer) or the like, and the data are collected and subjected to information processing by the PC or the like. For example, based on the collected data, the PC or the like associates measurement values from the plurality of recorders or measuring instruments with tags for each apparatus (also “measurement tags” hereinbelow) and displays the measurement values in lists on a monitor according to group, each group including a plurality of measurement tags. Moreover, whether a measurement-tag alarm needs to be output is determined on a screen of the PC or the like, and an alarm or the like is displayed on the monitor based on a determination result (for example, patent literature 1 and patent literature 2).

### Patent Literature

Patent Literature 1 JP 2018-120456 A

Patent Literature 2 JP 2019-207728 A

However, in the prior art, it is sometimes difficult for a user to instantly grasp for which measurement tag the alarm is being generated when measurement values of multiple measurement tags are being displayed on the monitor. Moreover, in the prior art, it is also sometimes difficult for the user to instantly grasp for which measurement tag the alarm is being generated when, for example, character strings of multiple alarm logs are being displayed together on the monitor. Moreover, it is not often the case that the user is continuously monitoring near the monitor, and there is also a risk of the user not noticing alarm generation. That is, there is room for improvement in art of presenting information on measurement tags to a user.

### SUMMARY

One or more embodiments provide an information display device, an information display method, and instructions that can improve art of presenting information on measurement tags to a user.

An information display device according to several embodiments is
an information display device, provided with: a display unit (i.e., display) that displays a display screen including information on measurement values respectively corresponding to a plurality of measurement tags; and a control unit (i.e., controller); wherein the control unit,
when at least one measurement value among the measurement values respectively corresponding to the plurality of measurement tags is greater than a first threshold, causes the display unit to display a pop-up screen including the information on the at least one measurement value superimposed on the display screen.

In this manner, when at least one measurement value among the measurement values is greater than the first threshold, the information display device according to several embodiments displays the pop-up screen including the information on the at least one measurement value superimposed on the display screen. As such, a user can quickly and easily recognize alarm generation and the information on the measurement value of the measurement tag relating to this alarm.

In one or more embodiments, a display size of the information on the at least one measurement value included in the pop-up screen may be greater than a display size of the information on the measurement values included in the display screen.

In this manner, displaying the display size of the information on the measurement value included in the pop-up screen to be large enables the user to quickly recognize alarm generation and the information on the measurement value of the measurement tag relating to this alarm.

In one or more embodiments, the control unit may further,
when at least one measurement value among the measurement values respectively corresponding to the plurality of measurement tags is at or below the first threshold and greater than a second threshold, cause the display unit to display a pop-up screen including the information on the measurement value indicated in a different display aspect than when this measurement value is greater than the first threshold superimposed on the display screen.

In this manner, when at least one measurement value among the measurement values is at or below the first threshold and exceeds the second threshold, the pop-up screen including the information on the measurement value indicated in a different display aspect than when the measurement value exceeds the first threshold is displayed superimposed on the display screen. As such, the user can quickly and easily recognize the information on the measurement value of a measurement tag having a high possibility of generating an alarm.

In one or more embodiments, the control unit may further
detect a selection operation of the information of the pop-up screen and cause the display unit to display related information relating to the measurement value included in the pop-up screen.

In this manner, detecting a selection operation in the pop-up screen and presenting the related information relating to the measurement value included in the pop-up screen enables user convenience to be further improved.

In one or more embodiments, the related information may be at least one of log information, video information, or distribution information on the measurement value.

In this manner, presenting at least one among log information or video information on the measurement value as the related information enables the user to recognize more detailed conditions relating to the alarm.

In one or more embodiments, the control unit may further
detect a deletion operation of the information included in the pop-up screen and stop displaying at least one unit of information among the information on the measurement values included in the pop-up screen.

In this manner, detecting a deletion operation in the pop-up screen and stopping display for at least one measurement value included in the pop-up screen can improve convenience by stopping display of information that is unnecessary to the user.

An information display method according to several embodiments includes
a step of displaying a display screen including information on measurement values respectively corresponding to a plurality of measurement tags and
a step, when at least one measurement value among the measurement values respectively corresponding to the plurality of measurement tags is greater than a first threshold, of displaying a pop-up screen including the information on the at least one measurement value superimposed on the display screen.

In this manner, when at least one measurement value among the measurement values is greater than the first threshold, the information display method according to several embodiments displays the pop-up screen including the information on the at least one measurement value superimposed on the display screen. As such, the user can quickly and easily recognize alarm generation and the information on the measurement value of the measurement tag relating to this alarm.

In instructions according to several embodiments, when the instructions are executed, a processor is made to execute operations including
a step of displaying a display screen including information on measurement values respectively corresponding to a plurality of measurement tags and
a step, when at least one measurement value among the measurement values of the plurality of measurement tags is greater than a first threshold, of displaying a pop-up screen including the information on the at least one measurement value superimposed on the display screen.

In this manner, when at least one measurement value among the measurement values is greater than the first threshold, the instructions according to several embodiments displays the pop-up screen including the information on the at least one measurement value superimposed on the display screen. As such, the user can quickly and easily recognize alarm generation and the information on the measurement value of the measurement tag relating to this alarm.

One or more embodiments of the present invention can provide an information display device, an information display method, and instructions that can improve art of presenting information on measurement tags to a user.

### BRIEF DESCRIPTION OF THE DRAWINGS

FIG. 1 is a functional block diagram of a system including an information display device according to one or more embodiments.

FIG. 2 is a flowchart illustrating an information display method according to one or more embodiments.

FIG. 3 is a display screen displayed by the information display device according to one or more embodiments.

FIG. 4 is a pop-up screen displayed by the information display device according to one or more embodiments.

FIG. 5 is a diagram illustrating related information displayed when a selection operation is detected in the pop-up screen.

FIG. 6 is a diagram illustrating a screen transition of when a deletion operation is detected in the pop-up screen.

FIG. 7 is a diagram illustrating another related information displayed when a selection operation is detected in the pop-up screen.

FIG. 8 is a diagram illustrating yet another related information displayed when a selection operation is detected in the pop-up screen.

FIG. 9 Another pop-up screen displayed by the information display device according to one or more embodiments.

### DETAILED DESCRIPTION

Embodiments of the present invention will be described herein with reference to the drawings. Those skilled in the art will recognize that many alternative embodiments can be accomplished using the teaching of the present invention and that the present invention is not limited to the embodiments illustrated herein for explanatory purposes.

A system 10 according to one or more embodiments is described below with reference to the drawings.

In each diagram, identical or corresponding portions are labeled with identical reference signs. In describing one or more embodiments, description of an identical or corresponding portion is omitted or simplified as appropriate.

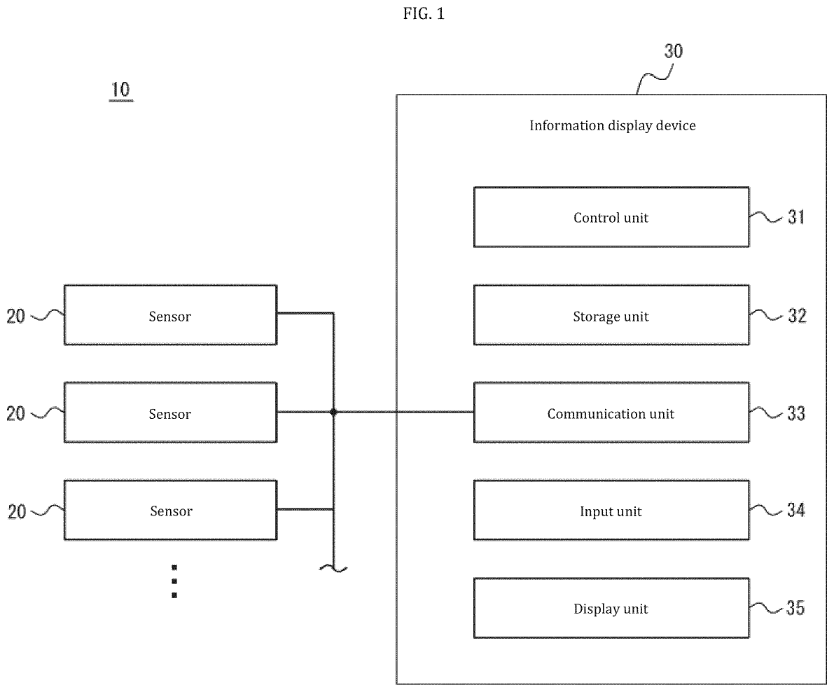

A configuration of the system 10 according to one or more embodiments is described with reference to FIG. 1.

The system 10 according to one or more embodiments includes a plurality of sensors 20 and an information display device 30. As one example, the sensor 20 may be a temperature sensor, a pressure sensor, a flowmeter, a current sensor, a voltage sensor, a gas sensor, or a measuring apparatus that measures any other physical quantity. The information display device 30 is, for example, a PC (personal computer) and is connected to the plurality of sensors 20. The information display device 30 collects data relating to measurement values measured by the plurality of sensors 20 and displays information to a user. The data relating to the measurement values measured by the plurality of sensors 20 are associated with measurement tags for each sensor 20, and a plurality of measurement tags is grouped. The groups that the measurement tags belong to can be freely established according to, for example, sensor type or location.

Referring once again to FIG. 1, a configuration of the information display device 30 according to one or more embodiments is described.

The information display device 30 includes a control unit 31, a storage unit 32, a communication unit 33, an input unit 34, and a display unit 35.

The control unit 31 includes at least one processor, at least one dedicated circuit, or a combination thereof. The processor is a general-purpose processor such as a CPU (central processing unit) or a GPU (graphics processing unit) or a dedicated processor specialized for specific processing. The dedicated circuit is, for example, an FPGA (field-programmable gate array) or an ASIC (application-specific integrated circuit). The control unit 31 executes processing relating to operations of the information display device 30 while controlling each unit of the information display device 30.

The storage unit 32 includes at least one semiconductor memory, at least one magnetic memory, at least one optical memory, or a combination of at least two types among these. The semiconductor memory is, for example, a RAM (random-access memory) or a ROM (read-only memory). The RAM is, for example, an SRAM (static random-access memory) or a DRAM (dynamic random-access memory). The ROM is, for example, an EEPROM (electrically erasable programmable read-only memory). The storage unit 32 functions as, for example, a main storage device, an auxiliary storage device, or a cache memory. The storage unit 32 stores data used in the operations of the information display device 30 and data obtained by the operations of the information display device 30.

The communication unit 33 includes at least one external-communication interface. The communication interface may be a wired-communication interface or a wireless-communication interface. When the communication interface is a wired-communication interface, this is, for example, a LAN (local area network) interface or USB (Universal Serial Bus). When the communication interface is a wireless-communication interface, this is, for example, an interface compatible with a mobile communication standard such as LTE (Long-Term Evolution), 4G (fourth generation), or 5G (fifth generation) or an interface compatible with near-field communication such as Bluetooth (registered trademark). The communication unit 33 receives the data used in the operations of the information display device 30 and transmits the data obtained by the operations of the information display device 30.

The input unit 34 includes at least one input interface. The input interface is, for example, a physical key, a capacitive key, a pointing device, a touch screen integrally included a display, or a microphone. The input unit 34 accepts an operation of inputting the data used in the operations of the information display device 30. The input unit 34 may be connected to the information display device 30 as an external input apparatus instead of being provided in the information display device 30. As a connection method, any method can be used, such as USB (Universal Serial Bus), HDMI (registered trademark) (High-Definition Multimedia Interface), or Bluetooth (registered trademark).

The display unit 35 includes at least one display-output interface. The output interface is, for example, a display. The display is, for example, an LCD (liquid-crystal display) or an organic EL (electroluminescent) display. The display unit 35 displays and outputs the data obtained by the operations of the information display device 30. The display unit 35 may be connected to the information display device 30 as an external output apparatus instead of being provided in the information display device 30. As a connection method, any method can be used, such as USB, HDMI (registered trademark), or Bluetooth (registered trademark).

Functions of the information display device 30 are realized by executing instructions according to one or more embodiments by the processor corresponding to the control unit 31. That is, the functions of the information display device 30 are realized by software. The instructions cause a computer to function as the information display device 30 by causing the computer to execute the operations of the information display device 30. That is, the computer functions as the information display device 30 by executing the operations of the information display device 30 according to the instructions.

In one or more embodiments, the instructions can record on a computer-readable recording medium. The computer-readable recording medium includes a non-transitory computer-readable medium and is, for example, a magnetic recording device, an optical disc, a magneto-optical recording medium, or a semiconductor memory. The instructions are distributed by selling, transferring, or lending a portable recording medium such as a DVD (digital versatile disc) or CD-ROM (compact disc read-only memory) whereon the instructions are recorded. Moreover, the instructions may be distributed by storing the instructions in storage of a server and transmitting the instructions from the server to another computer. Moreover, the instructions may be provided as a instructions product.

In one or more embodiments, for example, the computer temporarily stores the instructions recorded on the portable recording medium or the instructions transmitted from the server in the main storage device. Then, the computer uses the processor to read the instructions stored in the main storage device and uses the processor to execute processing according to the read instructions. The computer may directly read the instructions from the portable recording medium and execute the processing according to the instructions. The computer may, each time it receives instructions from the server, successively execute processing according to the received instructions. The processing may be executed by a so-called ASP (application service provider) service that does not transmit the instructions from a server to the computer but realizes the functions by execution instruction and result acquisition alone. The instructions include information that is used for processing by an electronic computer and amounts to instructions. For example, data that are not direct commands to the computer but have properties that define the computer's processing correspond to “information that . . . amounts to instructions”.

A portion or an entirety of the functions of the information display device 30 may be realized by the dedicated circuit corresponding to the control unit 31. That is, a portion or the entirety of the functions of the information display device 30 may be realized by hardware.

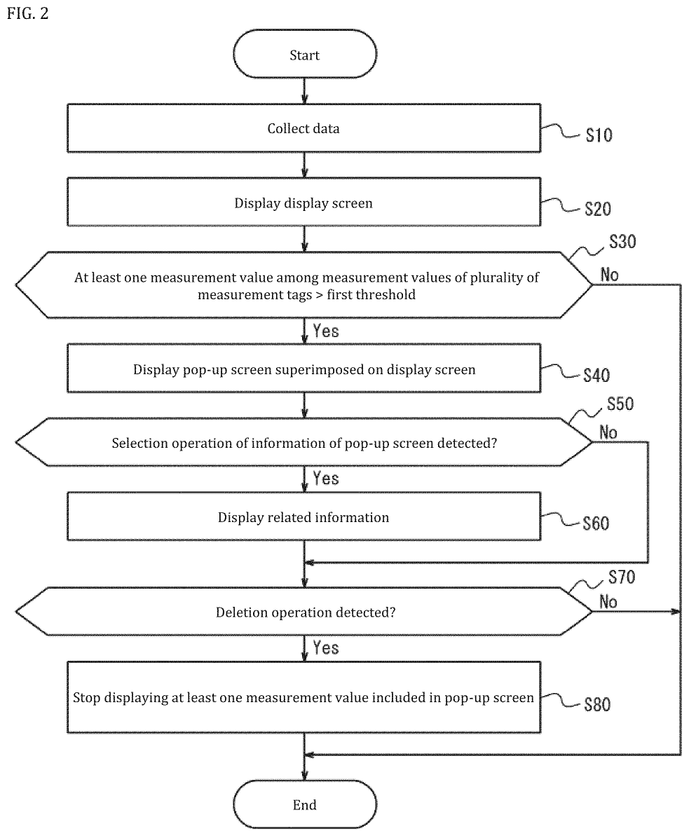

The operations of the information display device 30 according to one or more embodiments are described with reference to FIG. 2 to FIG. 9. FIG. 2 is a flowchart illustrating an information display method by the information display device 30.

First, the communication unit 33 of the information display device 30 collects the data relating to the measurement values measured by the plurality of sensors 20 (step S10). These data include information on the measurement values respectively corresponding to the plurality of measurement tags. The control unit 31 stores the collected data in the storage unit 32.

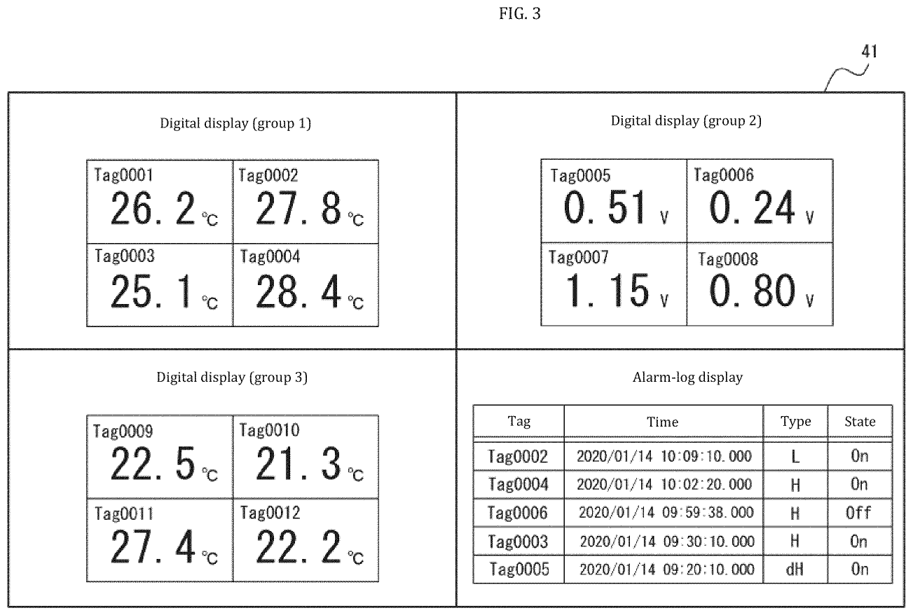

Next, based on the collected data, the control unit 31 displays a display screen on the display unit 35 (step S20). FIG. 3 illustrates one example of the display screen. The display screen 41 illustrated in FIG. 3 includes the information on the measurement values (digital values) respectively corresponding to the plurality of measurement tags. This information is updated in real time based on the data acquired from the sensors 20. FIG. 3 illustrates, as one example, an example wherein there are twelve measurement tags (Tag0001 to 0012). The measurement values corresponding to Tag0001 to Tag0004 are each a temperature and belong to group 1. The measurement values corresponding to Tag0005 to Tag0008 are each a voltage and belong to group 2. The measurement values corresponding to Tag0009 to Tag0012 are each a temperature and belong to group 3. The display screen 41 may further include an alarm-log display. The alarm-log display is a screen that lists log information on alarms generated in the past relating to the plurality of measurement tags.

Next, based on the collected data, the control unit 31 determines whether at least one measurement value among the measurement values of the plurality of measurement tags exceeds a first threshold (step S30). The first threshold is provided for each measurement tag and corresponds to an upper limit of a normal value of each measurement tag. In other words, the control unit 31 determines whether the measurement value corresponding to each measurement tag is an abnormal value. If at least one measurement value among the measurement values of the plurality of measurement tags is greater than the first threshold, the process proceeds to step S40. If at least one measurement value among the measurement values of the plurality of measurement tags is not greater than the first threshold, the process ends. Here, the first threshold is set by, for example, the information display device 30 receiving such from each sensor 20. The first threshold may differ for each sensor 20. This enables the normal value of the measurement value in each sensor 20 to be individually set.

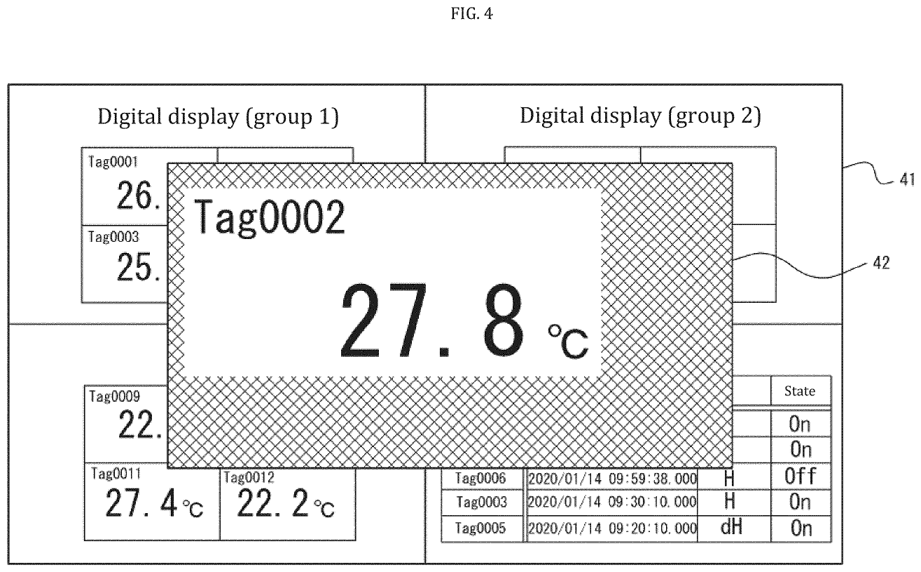

If at least one measurement value among the measurement values of the plurality of measurement tags is greater than the first threshold at step S30, the control unit 31 causes the display unit 35 to display a pop-up screen superimposed on the display screen (step S40). The pop-up screen includes the information on the at least one measurement value greater than the first threshold. In other words, if the measurement value is an abnormal value, the control unit 31 performs pop-up display for the information on this abnormal value as an alarm. FIG. 4 illustrates one example of the pop-up screen. The pop-up screen 42 illustrated in FIG. 4 includes the information on the measurement value corresponding to Tag0002 (here, 27.8° C.). The first threshold of Tag0002 is made to be, for example, 27° C.

Here, the information on the measurement value displayed in the pop-up screen 42 is displayed in a larger font than the information on the measurement values displayed in the display screen 41. In other words, a display size of the information on the at least one measurement value included in the pop-up screen 42 is greater than a display size of the measurement-value information of the display screen 41. This enables the user to quickly and easily recognize alarm generation and the information on the measurement value of the measurement tag relating to this alarm. Moreover, to display the information on the measurement value in a large size in the pop-up screen 42 in this manner, the pop-up screen 42 may be displayed in pages. That is, the pop-up screen 42 may include an upper-limit value of a number that is displayed at once, and display may be divided into a plurality of pages at a time. This upper-limit value may be, for example, 4. The control unit 31 may accept input of a page-turning operation on the pop-up screen 42 by the input unit 34. Moreover, the control unit 31 may control display in the pop-up screen 42 based on detecting input of a page-turning operation.

Following step S40, the control unit 31 detects a selection operation of the information displayed in the pop-up screen 42 (step S50). The selection operation is a predetermined operation by the user via the input unit 34 and is, for example, a clicking operation or a tapping operation of the information on the measurement value of any measurement tag of the pop-up screen 42. If a selection operation is detected, the process proceeds to step S60. If no selection operation is detected, the process proceeds to step S70.

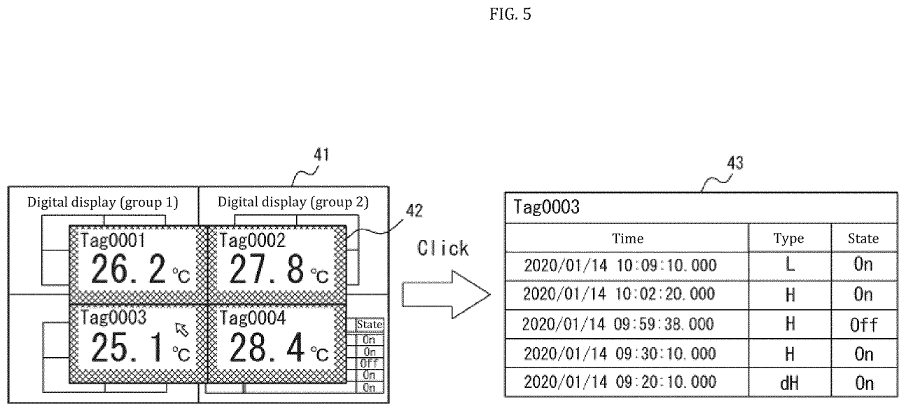

If a selection operation is detected at step S50, the control unit 31 causes the display unit 35 to display related information relating to the measurement value selected by the selection operation (step S60). In other words, the control unit 31 causes the display unit 35 to display related information relating to the measurement value included in the pop-up screen 42. FIG. 5 illustrates an example wherein the control unit 31 detects a selection operation of the measurement value of Tag0003 in the pop-up screen 42 and causes the display unit 35 to display related information 43 relating to this measurement tag. The related information 43 illustrated in FIG. 5 is log information on Tag0003—that is, historical information on measurement values and data at points in the past for Tag0003.

At step S70, the control unit 31 detects a deletion operation of the information displayed in the pop-up screen 42. The deletion operation is a predetermined operation by the user via the input unit 34 and is, for example, a clicking operation or a tapping operation of a close button respectively associated with the information on the measurement values of the measurement tags of the pop-up screen 42. If a deletion operation is detected, the process proceeds to step S80. If no selection operation is detected, the process ends.

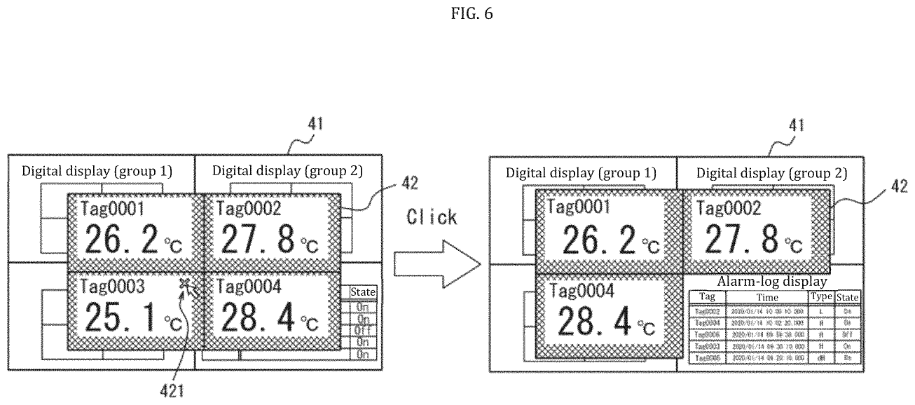

If a deletion operation is detected at step S70, the control unit 31 stops displaying at least one unit of information among the information on the measurement values included in the pop-up screen. FIG. 6 illustrates an example wherein the control unit 31 detects a deletion operation of the measurement value of Tag0003 in the pop-up screen 42 and stops displaying the information on this measurement tag. As illustrated in FIG. 6, when a clicking operation of a close button 421 corresponding to Tag0003—that is, a deletion operation—is detected, the control unit 31 stops displaying the information on the measurement value of Tag0003. Moreover, in conjunction with this processing of stopping display, the control unit 31 causes the display unit 35 to display the other information (here, Tag0001, Tag0002, and Tag0004) upon changing an arrangement of this information.

In this manner, according to the information display device 30 according to one or more embodiments, when at least one measurement value among the measurement values exceeds the first threshold, the display unit 35 is made to display the pop-up screen 42 including the information on this at least one measurement value superimposed on the display screen 41. As such, the user can quickly and easily recognize alarm generation and the information on the measurement value of the measurement tag relating to this alarm.

Furthermore, in the information display device 30 according to one or more embodiments, the control unit 31 may detect a selection operation of the information displayed in the pop-up screen 42. Moreover, based on this detection, the control unit 31 uses the display unit 35 to present related information relating to the measurement value included in the pop-up screen. This enables the user to speedily recognize the information relating to the measurement value relating to the alarm and can increase user convenience.

Furthermore, in the information display device 30 according to one or more embodiments, the control unit 31 may detect a deletion operation of the information in the pop-up screen 42. Based on this detection, display can be stopped for at least one of the measurement values included in the pop-up screen 42 to improve convenience by stopping display of information that is unnecessary to the user.

One or more embodiments of the present invention is described based on the drawings and an example. However, a person skilled in the art can easily make many different variations and modifications based on one or more embodiments. Note therefore that these variations and modifications are included in the scope of one or more embodiments of the present invention. For example, the functions or the like included in each configuration, each step, or the like can be rearranged so as to not logically contradict, and a plurality of configurations, steps, or the like can be combined into one or be divided.

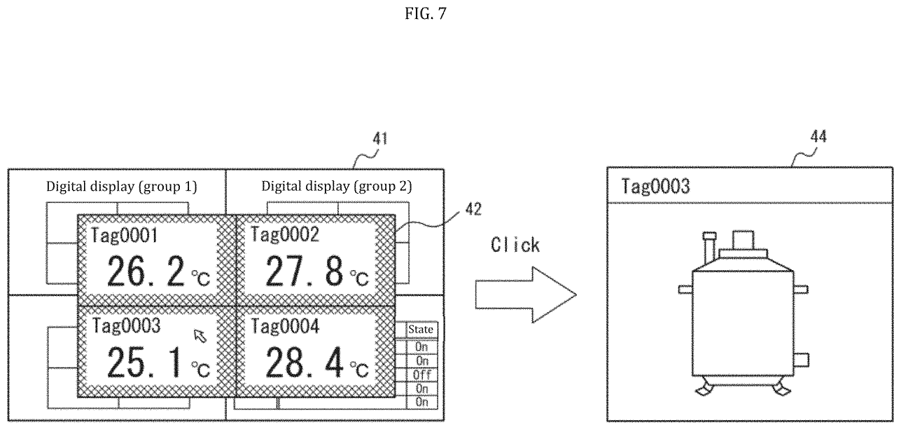

For example, in the above, an example is illustrated of displaying log information on the selected measurement tag as the related information, but the present disclosure is not limited thereto. FIG. 7 is a diagram illustrating another example of the related information displayed when a selection operation is detected in the pop-up screen 42. The related information 44 illustrated in FIG. 7 is video information corresponding to the measurement tag of the selection operation. For example, it is supposed that the measurement value whose measurement tag is Tag0003 is a tank temperature. In this situation, as illustrated in FIG. 7, the display unit 35 displays video information. By presenting video information corresponding to the measurement tag in this manner, the user can recognize the measurement value as well as more detailed conditions relating to the alarm, such as surrounding conditions.

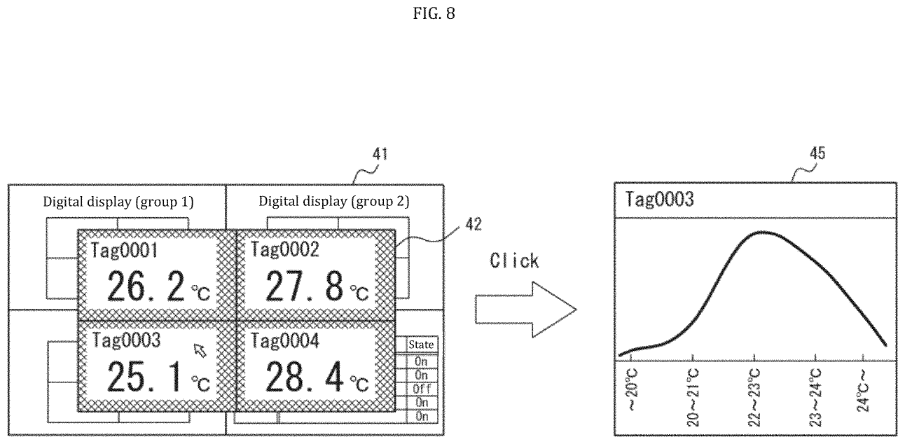

Furthermore, FIG. 8 is a diagram illustrating yet another example of the related information displayed when a selection operation is detected in the pop-up screen 42. The related information 45 illustrated in FIG. 8 is distribution information on the measurement value corresponding to the measurement tag of the selection operation. The measurement-value distribution information enables the user to grasp whether the current measurement value is a sudden indication of an abnormal value—in other words, whether the measurement value has continuously been an abnormal value—and the user can recognize more detailed information on the alarm.

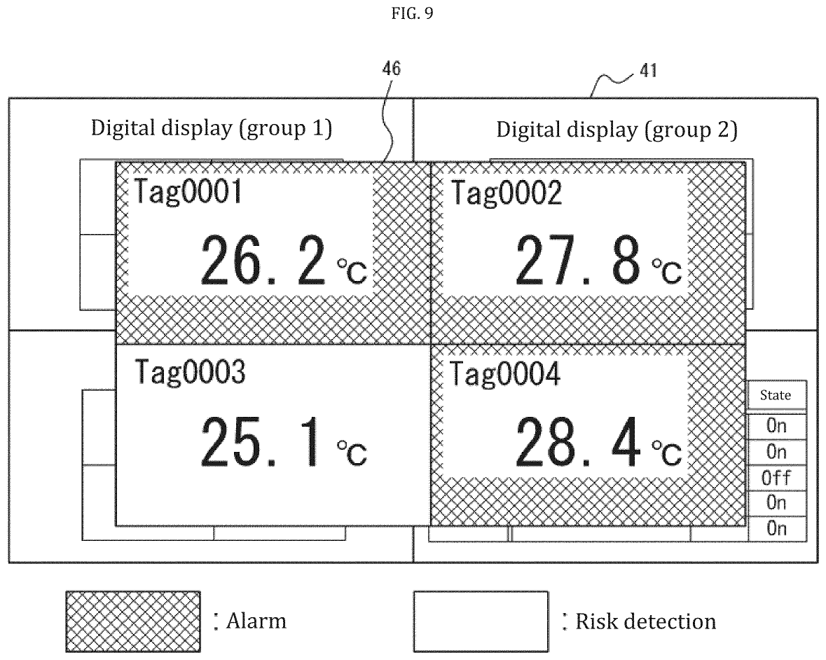

As another example, in the above, the control unit 31 displays the pop-up screen 42 based on a comparison between the measurement value and the first threshold, but the present disclosure is not limited thereto. For example, the control unit 31 may perform, in addition to a comparison with the first threshold, a comparison between the measurement value and a second threshold that is lower than the first threshold. For example, a measurement value may be detected as having a high possibility of generating an alarm in the future despite being below the abnormal value whereat the alarm is to be presented, and this information may be included in the pop-up screen. In other words, the control unit 31 may perform risk detection of the measurement value. Moreover, on the pop-up screen, the measurement value exceeding the first threshold and the measurement value that is at or below the first threshold and exceeds the second threshold are displayed by the display unit 35 so as to be distinguishable. That is, when at least one measurement value among the measurement values respectively corresponding to the plurality of measurement tags is at or below the first threshold and greater than the second threshold, the control unit 31 performs, on the display unit 35 and using the display unit 35, superimposed display of a pop-up screen including the information on the measurement value indicated in a different display aspect than when the measurement value is greater than the first threshold. FIG. 9 illustrates one example of this pop-up screen. In the pop-up screen 46 illustrated in FIG. 9, measurement values exceeding the first threshold (Tag0001, Tag0002, Tag0004) and a measurement value that is less than the first threshold and exceeds the second threshold (Tag0003) are displayed in different display aspects. For example, a background color of the measurement value of Tag0003 may be a first color (for example, yellow). Meanwhile, a background color of the measurement values of Tag0001, Tag0002, and Tag0004 may be a second color (for example, red). In this manner, displaying a measurement value exceeding the first threshold and a measurement value that is at or below the first threshold and exceeds the second threshold in a distinguishable manner enables the user to appropriately grasp an alarm and information on risk detection.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

10 System

20 Sensor

30 Information display device

31 Control unit

32 Storage unit

33 Communication unit

34 Input unit

35 Display unit

41 Display screen

42, 46 Pop-up screen

43, 44, 45 Related information

421 Close button

What is claimed is:

1. An information display device, comprising:
a display that displays a display screen including information on measurement values respectively corresponding to measurement tags; and
a controller, wherein
when one or more of the measurement values are greater than a first threshold, the controller causes the display to display a first pop-up screen, including information on the one or more measurement values, superimposed on the display screen.

2. The information display device according to claim 1, wherein
a display size of the information on the one or more measurement values on the first pop-up screen is larger than a display size of the information on the measurement values on the display screen.

3. The information display device according to claim 1, wherein
when the one or more measurement values are less than or equal to the first threshold and greater than a second threshold, the controller further causes the display to display a second pop-up screen superimposed on the display screen, and
a display aspect of the first pop-up screen is different from a display aspect of the second pop-up screen.

4. The information display device according to claim 1, wherein the controller further:
detects a selection operation of the information of the first pop-up screen, and
based on the detection of the selection operation, causes the display to display related information relating to the one or more measurement values.

5. The information display device according to claim 4, wherein the related information is at least one of log information, video information, or distribution information on the one or more measurement values.

6. The information display device according to claim 1, wherein the controller further:
detects a deletion operation of the information on the first pop-up screen, and
based on the detection of the deletion operation, stops displaying at least one of the information on the first pop-up screen.

7. An information display method, comprising:
displaying a display screen including information on measurement values respectively corresponding to measurement tags; and
when one or more of the measurement values are greater than a first threshold, displaying a pop-up screen, including information on the one or more measurement values, superimposed on the display screen.

8. A non-transitory computer-readable medium storing instructions, wherein when the instructions are executed, a processor is made to execute operations comprising:
displaying a display screen including information on measurement values respectively corresponding to measurement tags; and
when one or more of the measurement values are greater than a first threshold, displaying a pop-up screen, including information on the one or more measurement values, superimposed on the display screen.
